(19) United States
(12) Patent Application Publication
(10) Pub. No.: US 2005/0097195 A1
(43) Pub. Date: May 5, 2005

(54) Procedure downloading system and method

(75) Inventors: Chi-Chih Wang, Tu-Cheng (TW); Bing-Yu He, Shenzhen (CN); Zhi-Meng Cao, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/927,804

(22) Filed: Aug. 27, 2004

(30) Foreign Application Priority Data
Oct. 31, 2003 (TW) 092130561

(51) Int. Cl. G06F 15/173; G06F 15/177

(52) U.S. Cl. 709/221; 709/224

(57) ABSTRACT

A procedure downloading system includes a web server (2), a database server (1), a video server (6), and monitor computers (5) linking to the web server through a communication means (4). The web server includes: an IP (Internet Protocol) address obtaining module (22) for obtaining IP addresses from said monitor computers; an IP address determination module (23) for determining whether an obtained IP address is already in the database server; a download request receiving module (24) for receiving a procedure download request from a monitor computer if the obtained IP address is not in the database server; a procedure downloading module (25) for downloading a communication procedure to the monitor computer according to the received procedure download request; and a procedure installing module (26) for installing the downloaded communication procedure in the monitor computer. A related procedure downloading method is also disclosed.

### BACKGROUND OF THE INVENTION

1. Field of the Invention

The present invention relates generally to systems and methods for automated process monitoring, and more particularly to a procedure downloading system and method which can download communication procedures automatically from a remote server to any of monitoring computers.

2. Background of the Invention

A shop floor control system is an industry standard term describing a computer-based system that provides access to all manufacturing activities that generally take place in manufacturing sites. The manufacturing activities typically include master production scheduling, process monitoring, quality control, and so on. Monitoring manufacturing processes is important for a manufacturing enterprise's success because of the high cost of various manufacturing errors. Manufacturing errors can result in wastage of raw materials, machine down time, and reworking or scrapping of defective products. The cost of a manufacturing error is minimized when the error is detected and corrected at the earliest possible time in the manufacturing process. Problems can be detected and resolved at the earliest possible time and at the lowest possible cost through real-time process monitoring.

A conventional process monitoring system comprises operations of various detection equipment and sensors, with a central monitoring device collecting various data on the process at predetermined intervals of time. When an abnormality is detected in the process, the central monitoring device notifies supervising personnel via a computer terminal display such as a CRT (Cathode-Ray Tube). Information concerning the occurrence of the abnormality is displayed on the CRT, thereby enabling the supervising personnel to remedy the abnormality appropriately and quickly. However, the process monitoring system generally uses special monitoring equipment, which is expensive.

Another process monitoring method is disclosed in U.S. Pat. No. 6,510,352 issued on Jan. 21, 2003 and entitled Methods And Apparatus For Object-based Process Control. The patent provides a plurality of control devices that provide virtual machine environments in which Java objects, or other such software constructs, are executed to implement process control. These objects define blocks, which are the basic functional units of the control. They also define input, output and body parts from which blocks are formed, and the signals that are communicated between blocks. The objects also define nested and composite groupings of blocks used to control loops and higher-level control functions. However, the supervising personnel need to manually download communication procedures.

To overcome the foregoing problems, what is need is a system and method for automatically downloading needed communication procedures from a remote server and installing the communication procedures into corresponding monitor computers.

### SUMMARY OF THE INVENTION

It is an objective of the present invention to provide a system and method which can automatically download communication procedures from a remote server to monitor computers and install the communication procedures in the monitor computers thereby enabling the monitor computers to monitor operations of manufacturing sites.

To accomplish the above objective, a procedure downloading system in accordance with a preferred embodiment of the present invention comprises a web server, a database server, a video server and a plurality of monitor computers linking to the web server through a communication means. The web server comprises: an IP (Internet Protocol) address obtaining module for obtaining IP addresses from said monitor computers; an IP address determination module for determining whether each obtained IP address is already in the database server; a download request receiving module for receiving a communication procedure download request from a corresponding monitor computer if the obtained IP address is not in the database server; a procedure downloading module for downloading a communication procedure to the monitor computer according to the received communication procedure download request; and a procedure installing module for installing the downloaded communication procedure in the monitor computer.

Further, a preferred procedure downloading method according to the present invention is also provided. The method comprises the following steps: obtaining an IP (Internet Protocol) address from one of said monitor computers; determining whether the obtained IP address is already in a database server; receiving a communication procedure download request from the monitor computer if the obtained IP address is not in the database server; downloading the communication procedure to the monitor computer; and installing the downloaded communication procedure in the monitor computer.

Other objects, novel features and advantages of the present invention will be drawn from the following detailed description of the present invention with the attached drawings, in which:

### BRIEF DESCRIPTION OF THE DRAWINGS

FIG. 1 is a schematic diagram of hardware configuration of a procedure downloading system in accordance with the preferred embodiment of the present invention;

FIG. 2 is a schematic diagram of main software function modules of a web server of the procedure downloading system of FIG. 1; and

FIG. 3 is a flowchart of a preferred procedure downloading method according to the present invention, utilizing the procedure downloading system of FIG. 1.

### DETAILED DESCRIPTION OF THE INVENTION

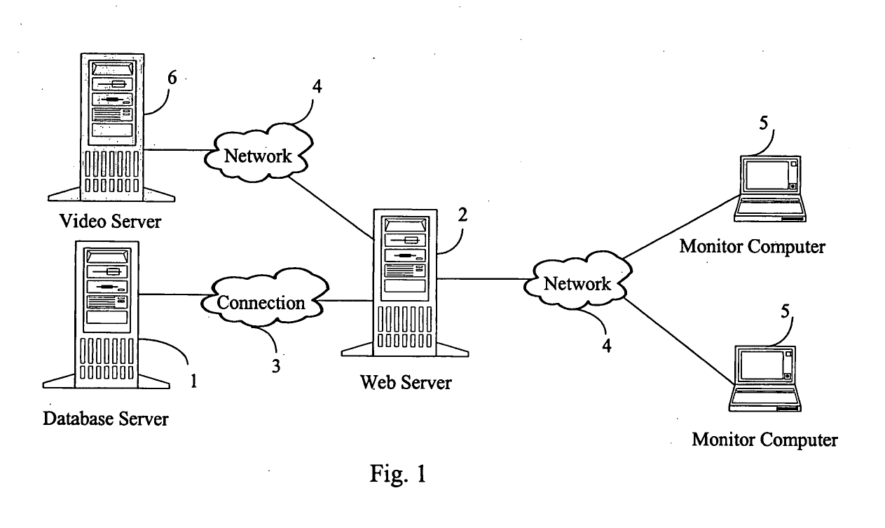

FIG. 1 is a schematic diagram of hardware configuration of a procedure downloading system in accordance with the preferred embodiment of the present invention. The procedure downloading system comprises a database server 1, a web server 2, a plurality of monitor computers 5 (only two shown), and a video server 6. The video server 6 is used to receive video data captured by cameras (not shown) installed at various manufacturing sites. The database server 1 is connected with the web server 2 via a connection 3. The connection 3 is a kind of database connectivity such as an ODBC (Open Database Connectivity) or a JDBC (Java Database Connectivity). The database server 1 is used for storing information on authorized users and IP (Internet Protocol) addresses of monitor computers 5 that have had a communication procedure installed therein. Information on each authorized user comprises a user ID and a password. Each monitor computer 5 is connected with the web server 2 through a network 4, and may be used to run the communication procedure in order to obtain video data from the video server 6 for monitoring of operations of various manufacturing sites. The network 4 may be an intranet, the Internet, or any other suitable communications network.

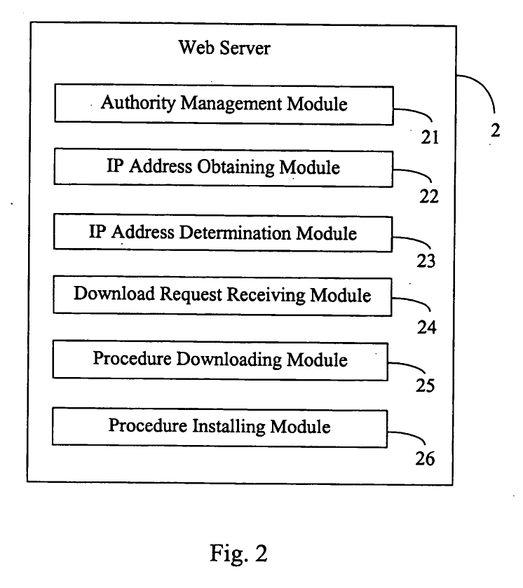

FIG. 2 is a schematic diagram of software function modules of the web server 2. The web server 2 is provided to receive communication procedure download requests, to download a communication procedure to any monitor computer 5, and to install the communication procedure in the monitor computer 5. The web server 2 comprises an authority management module 21, an IP address obtaining module 22, an IP address determination module 23, a download request receiving module 24, a procedure downloading module 25, and a procedure installing module 26.

The authority management module 21 is provided to receive user IDs and corresponding passwords from any monitor computer 5, determine whether any user is an authorized user, and to reject access by the user if the user is not an authorized one. The IP address obtaining module 22 is provided to obtaining IP addresses from the monitor computers 5. The IP address determination module 23 is provided to determine whether each obtained IP address exists in the database server 1. The download request receiving module 24 is provided to receive a communication procedure download request from a corresponding monitor computer 5 if the IP address obtained from that monitor computer 5 does not exist in the database server 1. The procedure downloading module 25 is provided to download the communication procedure to the monitor computer 5 according to the communication procedure download request. The procedure installing module 26 is provided to install the downloaded communication procedure in the monitor computer 5, and to store the IP address of the monitor computer 5 in the database server 1.

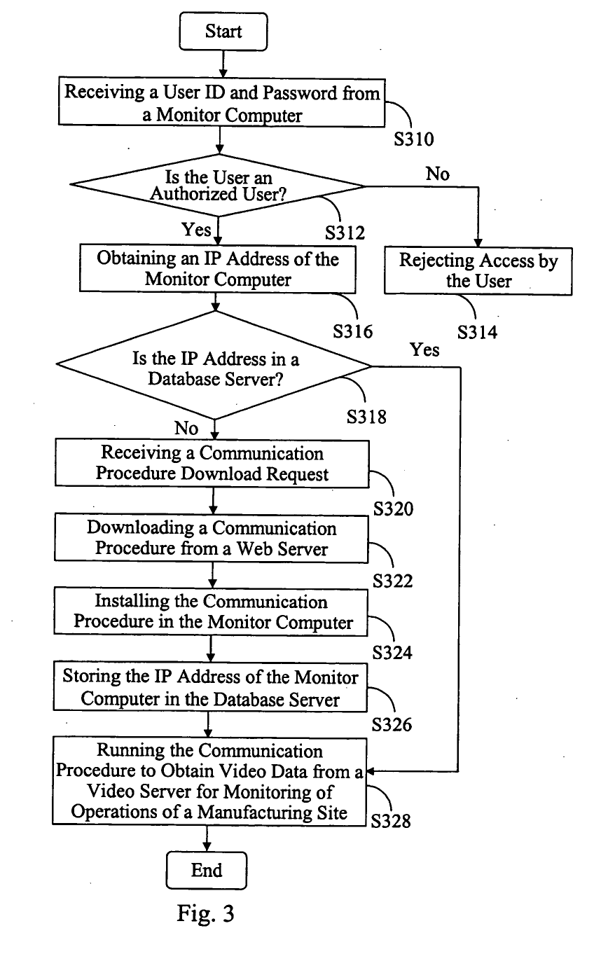

FIG. 3 is a flowchart of a preferred procedure downloading method in accordance with the present invention. In step S310, the authority management module 21 receives a user ID and password from a monitor computer 5. In step S312, the authority management module 21 determines whether the user is an authorized user according to the information on authorized users stored in the database server 1. If the user is not an authorized user, in step S314, the authority management module 21 rejects access by the user. If the user is an authorized user, in step S316, the IP address obtaining module 22 obtains an IP address from the monitor computer 5. In step S318, the IP address determination module 26 determines whether the obtained IP address is already in the database server 1. If the obtained IP address is already in the database server 1, the procedure goes directly to step S328 described below.

Otherwise, in step S320, the download request receiving module 24 receives a procedure download request from the monitor computer 5. In step S322, the procedure downloading module 25 downloads the communication procedure to the monitor computer 5 according to the received procedure download request. In step S324, the procedure installing module 26 installs the downloaded communication procedure in the monitor computer 5. In step S326, the procedure installing module 26 stores the IP address of the monitor computer 5 in the database server 1. In step S328, the monitor computer 5 runs the communication procedure in order to obtain video data from the video server 6 for monitoring of operations of the manufacturing site.

Although the present invention has been specifically described on the basis of a preferred embodiment and preferred method, the invention is not to be construed as being limited thereto. Various changes or modifications may be made to said embodiment and method without departing from the scope and spirit of the invention.

1. A procedure downloading system comprising a web server, a database server, a video server and one or more monitor computers linking to the web server through a communication means, wherein the web server comprises:
an IP (Internet Protocol) address obtaining module for obtaining IP addresses from said monitor computers;
an IP address determination module for determining whether each obtained IP address is already in the database server;
a download request receiving module for receiving a communication procedure download request from a corresponding monitor computer if the obtained IP address is not in the database server;
a procedure downloading module for downloading a communication procedure to the monitor computer according to the received communication procedure download request; and
a procedure installing module for installing the downloaded communication procedure in the monitor computer.

2. The procedure downloading system according to claim 1, wherein the web server further comprises an authority management module for receiving user IDs and passwords from said monitor computers.

3. The procedure downloading system according to claim 2, wherein the authority management module is also for determining whether a user is an authorized user, and for rejecting access by an unauthorized user.

4. The procedure downloading system according to claim 1, wherein the procedure installing module is also for storing the IP address of the monitor computer in the database server.

5. A method for downloading a communication procedure from a remote server to one or more monitor computers, the method comprising the steps of:
obtaining an IP (Internet Protocol) address from one of said monitor computers;
determining whether the obtained IP address is already in a database server;
receiving a communication procedure download request from the monitor computer if the obtained IP address is not in the database server;
downloading the communication procedure to the monitor computer; and
installing the downloaded communication procedure in the monitor computer.

6. The method according to claim 5, further comprising the step of receiving a user ID and password from the monitor computer.

7. The method according to claim 6, further comprising the step of determining whether a user is an authorized user according to the user ID and password.

8. The method according to claim 6, further comprising the step of rejecting access by the user if the user is not an authorized user.

9. The method according to claim 5, further comprising the step of storing the IP address of the monitor computer in the database server if the obtained IP address is not in the database server.

10. The method according to claim 5, wherein the communication procedure is for enabling the monitor computer to obtain video data from a video server for monitoring of operations of a manufacturing site.

11. A method for automatically installing a suggestive communication procedure from a remote server to a user's monitor computer, the method comprising the steps of:
acquiring automatically an IP (Internet Protocol) address of said user's monitor computer to;
verifying said acquired IP address with identifiable IP addresses saved in a database server to identify a use status of said suggestive communication procedure in said user's monitor computer;
inquiring availability of a communication procedure download request from said user's monitor computer in a condition of a negative identification to said use status of said suggestive communication procedure; and
providing a downloadable and installable program of said suggestive communication procedure to said user's monitor computer as a result of getting said communication procedure download request from said user's monitor computer.

12. The method according to claim 11, further comprising the step of verifying a valid user of said user's monitor computer.

13. The method according to claim 11, further comprising the step of downloading and installing said suggestive communication procedure to said user's monitor computer.
